(19) United States
(12) Patent Application Publication
(10) Pub. No.: US 2010/0057513 A1
(43) Pub. Date: Mar. 4, 2010

(54) AUTOMATIC APPOINTMENT SCHEDULER WITH HYBRID TIMELINE

(75) Inventor: David Paul Carlson, Shoreview, MN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/198,436

(22) Filed: Aug. 26, 2008

(51) Int. Cl. G06Q 10/00

(52) U.S. Cl. 705/8

(57) ABSTRACT

An apparatus, method and computer program product are provided for creating and displaying a hybrid timeline including a contiguous and a non-contiguous portion that may be used to schedule an appointment. The contiguous portion may include a time entry associated with each of several consecutive time periods during which one or more appointments may be scheduled. These time entries may include sufficient detail to enable a scheduler to schedule an appointment during a time slot within the corresponding time period. The non-contiguous portion may, in turn, include time entries associated with only relevant time periods associated with the party for whom an appointment is to be scheduled, spread over a larger amount of time and including less detail than the time entries of the contiguous portion. Together, the contiguous and non-contiguous portions may comprise a single timeline on which substantially all relevant events may be presented with time-sequential integrity intact.

### FIELD

Embodiments of the invention relate, generally, to scheduling appointments and, in particular, to an automated method and system for scheduling appointments (e.g., recurring appointments) using a hybrid timeline.

### BACKGROUND

When scheduling an appointment and, in particular, when scheduling recurring appointments, such as appointments to see a physical therapist, dentist, orthodontist, or other physician, appointments to have your car's oil changed and/or to have scheduled maintenance on your car (e.g., 30,000-, 60,000-, etc. mile maintenance checks), appointments to have your house cleaned, your dog groomed, your hair done and/or the like, it is often desirable for the party scheduling the appointment to be able to view certain information, such as the availability of equipment and/or personnel, spread over a vast amount of time. For instance, a veterinarian attempting to schedule bimonthly appointments to groom a dog over the next year may need to view information regarding the days the dog groomer and/or one or more rooms used for dog grooming will be available over at least the next several months in order to help select a consistent schedule.

In addition, however, it may be also desirable to view more detailed information in relation to at least certain periods of time. For example, continuing with the example above, the veterinarian may also find it helpful to view information regarding the days and times at which the dog's owner has other appointments (e.g., flea treatments, annual exams, etc.) scheduled with the veterinarian in association with the dog being groomed or even another pet owned by the owner. By knowing this information, the veterinarian may, for example, attempt to schedule at least some of the grooming appointments close in time to another appointment requiring the dog's owner to be at the veterinarian's office.

In many instances the party scheduling appointments may be doing so using a personal computer (PC), laptop, or other electronic device, executing some form of appointment scheduling software. With the limitations in electronic device screen sizes, simultaneously satisfying these two desires (i.e., to view date and time information that both spans a vast amount of time and provides significant detail in relation to at least a certain span of time) may be difficult.

A need, therefore, exists for an appointment scheduling system that addresses at least some of these and other drawbacks and challenges.

### BRIEF SUMMARY

In general, embodiments of the present invention provide an improvement by, among other things, providing an appointment scheduling system and method for creating and displaying a hybrid timeline including both a contiguous and a non-contiguous portion that may be used to schedule an appointment. Together, the contiguous and non-contiguous portions may comprise a single timeline on which substantially all relevant events may be presented with time-sequential integrity intact. According to one embodiment, the contiguous portion of the hybrid timeline may include a time entry associated with each of several consecutive time periods (e.g., days) during which one or more appointments may be scheduled. These time entries may include sufficient detail to enable a scheduler to schedule an appointment during one or more time slots (e.g., a half-hour or hour long time slot) within the corresponding time period. For example, each time entry of the contiguous portion of the hybrid timeline may include an indication of the time slots during which all of the necessary personnel and/or equipment are available to schedule the desired appointment and, in contrast, those in which they are not.

According to one embodiment, the non-contiguous portion of the hybrid timeline may, in turn, include time entries associated with only relevant time periods (e.g., days) associated with the party for whom an appointment is to be scheduled, spread over a larger amount of time. For example, the non-contiguous portion of the hybrid timeline may include a time entry for each time period during which either the party already has an appointment scheduled or it is suggested that he or she schedule a needed appointment. The non-contiguous portion may not include time entries corresponding to time periods that are not relevant to the patient, or do not represent a time period during which something is already scheduled or should be scheduled. Accordingly, the non-contiguous portion of the hybrid timeline may provide a context for the party for whom an appointment is being scheduled. In order to include time entries associated with all relevant time periods spanning a vast amount of time, the times entries associated with the non-contiguous portion of the hybrid timeline may, in one embodiment, include less detail than the time entries of the contiguous portion of the hybrid timeline. For example, the non-contiguous portion may not include information regarding available time slots within each of the time periods.

According to one aspect, an apparatus for scheduling appointments is provided. In one embodiment, the apparatus may include a processor that is configured to cause a display of a timeline capable of being used to schedule an appointment, wherein the timeline may include a contiguous portion and a non-contiguous portion. In one embodiment, the contiguous portion may include two or more entries corresponding to two or more consecutive time frames, a first of the entries corresponding to a suggested time frame for scheduling a first of a plurality of new appointments. The non-contiguous portion may only include an entry corresponding to a suggested time frame for scheduling respective remaining new appointments of the plurality of new appointments, and an entry corresponding to a time frame within which respective appointments of one or more previously-scheduled appointments has been scheduled, without including an entry that fails to correspond to either a suggested time frame for scheduling one of the plurality of new appointments or a time frame within which one of the one or more previously-scheduled appointments has been scheduled.

According to another aspect, a method for scheduling appointments is provided. In one embodiment, the method may include: (1) generating a timeline capable of being used to schedule an appointment, wherein the timeline may comprise the contiguous portion and the non-contiguous portion described above; and (2) causing a display of the timeline.

According to yet another aspect a computer program product for scheduling appointments is provided. In one embodiment, the computer program product may include at least one computer-readable storage medium having computer-readable program code portions stored therein, wherein the computer-readable program code portions may include: (1) a first executable portion for generating a timeline capable of being used to schedule an appointment, wherein the timeline may comprise the contiguous portion and the non-contiguous portion described above; and (2) a second executable portion for causing a display of the timeline.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram of one type of system that may benefit from embodiments of the present invention;

FIG. 2 is a schematic block diagram of a central server according to one embodiment of the present invention;

FIG. 3 is a flow chart illustrating the process of scheduling appointments in accordance with embodiments of the present invention;

FIGS. 4A-4C illustrate a graphical user interface that may be used to generate a recurring appointment set in accordance with embodiments of the present invention; and

FIGS. 5A-5K illustrate a graphical user interface that may be used to schedule one or more appointments in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overall System and Central Server:

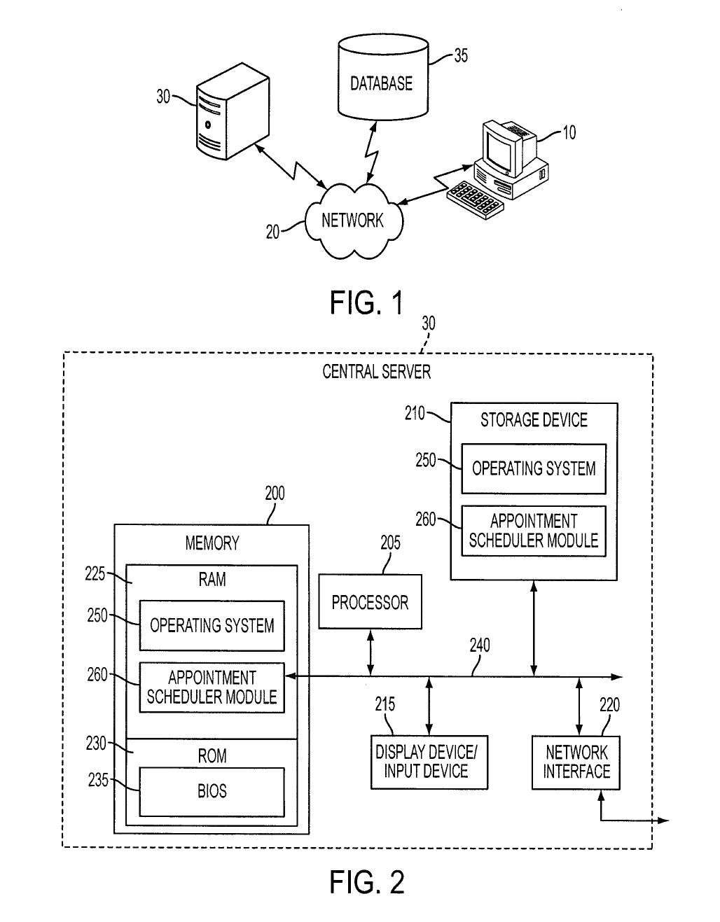

Reference is now made to FIG. 1, which provides a block diagram of one type of system that may benefit from embodiments of the present invention. As shown, the system may include one or more electronic devices (e.g., personal computers (PCs), laptops, personal digital assistants (PDAs), etc.) 10 which may be used, for example, to schedule a new appointment, such as a new recurring appointment for a person to see a physical therapists, dentist, orthodontist, or other physician, have his or her hair done, take his or her dog in to be groomed, have his or her car serviced, and/or the like, wherein scheduling a “new” appointment may refer to either scheduling an appointment for the first time or rescheduling a previously scheduled appointment. As one of ordinary skill in the art will recognize in light of this disclosure, embodiments of the present invention may be used to schedule single and/or recurring appointments of any type.

In order to schedule an appointment, or several recurring appointments, the electronic device 10 may be in electronic communication with a central server or computing system 30 over a wireless or wired network 20 including, for example, a wired or wireless Personal Area Network (PAN), Local Area Network (LAN), Wide Area Network (WAN), and/or the like. As discussed in more detail below with regard to FIGS. 2 though 5K, the central server, or similar network entity, 30 may, in turn be configured to cause the display of (e.g., on a display screen associated with the electronic device 10) a timeline capable of being used to schedule the appointment(s) (referred to herein as a “hybrid timeline”), wherein the hybrid timeline may include a contiguous and a non-contiguous portion.

In one embodiment, the contiguous portion may include entries corresponding to consecutive time frames (e.g., days), wherein the first entry may correspond to a suggested time frame (e.g., day) for scheduling the first of several appointments. The non-contiguous portion, which may be used to provide a context for the party for whom an appointment is being scheduled (i.e., to illustrate what else is going on in association with the party), may, in turn, include an entry corresponding to a suggested time frame (e.g., day) for scheduling each of the remaining appointments to be scheduled, as well as an entry corresponding to each previously-scheduled appointment associated with the party. According to one embodiment, the non-contiguous portion may not include an entry for a time frame that is neither a suggested time frame nor a time frame during which a previously-scheduled appointment is scheduled. In other words, the non-contiguous portion may only include time frames (e.g., days) on or during which something is already scheduled or it is suggested that something be scheduled. According to one embodiment, each portion may display information with some level of detail, wherein the level of detail provided by the contiguous portion may be greater than that provided by the non-contiguous portion.

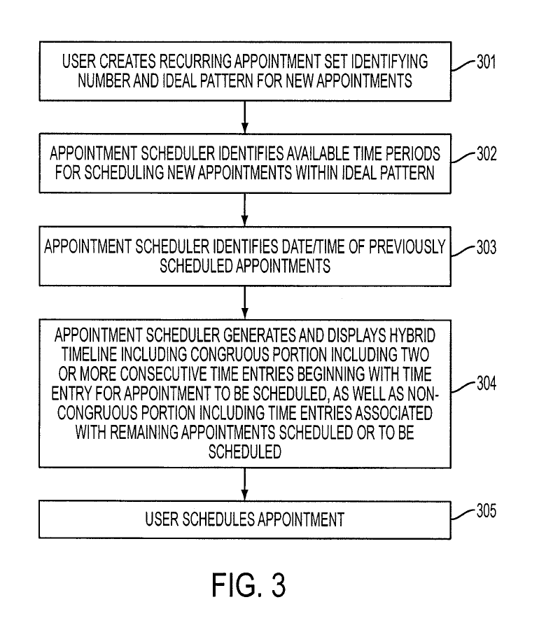

To illustrate, for example, as discussed in more detail below with regard to FIGS. 3 through 5K, assume that a patient recently scheduled semiannual appointments to have his or her teeth cleaned, and that he or she has already scheduled these appointments to occur on May 15^{th} and November 15^{th} of each year for the next 10 years. Further assume that the patient contacts the dentist's office on April 30^{th} of this year to request to have a cosmetic teeth-whitening procedure performed at the earliest available time, and that the only dentist in the office who performs this particular procedure is on vacation until May 5^{th} of this year. According to embodiments of the present invention, the hybrid timeline caused to be displayed by the central server 30 may include, for example, a contiguous portion that includes an entry corresponding to May 5^{th} of this year, or the suggested day for scheduling the teeth-whitening procedure (e.g., since it is the first day the particular dentist is available), along with entries corresponding, for example, to May 6^{th}, 7^{th}, 8^{th}, and 9^{th} of this year, or the consecutive time frames following the suggested time frame. The level of detail of the information included in these consecutive entries may include, for example, the hours and minutes at which certain equipment and/or personnel are available to schedule the appointment.

According to embodiments of the present invention, the timeline may further include a non-contiguous portion including only entries associated with May 15^{th} and November 15^{th} of this year and each of the next nine years, wherein the level of detail associated with the information displayed in these entries may include only date (and not time) information. This portion of the timeline may provide the party scheduling the appointment (referred to hereinafter as the “scheduler”) a context associated with the patient, or an indication of what other appointments are scheduled in association with the patient.

Using this hybrid timeline the scheduler (e.g., the receptionist at the dentist's office using his or her electronic device 10 to access the central server 30) may decide that, rather than scheduling the patient's teeth-whitening procedure on the next available day (i.e., May 5^{th} of this year), it may be better to schedule the appointment on May 15^{th} of this year, since the patient is already scheduled to visit the dentist's office on that day for his or her semiannual appointment. In other words, according to embodiments of the present invention, a scheduler may be able to view contextual information associated with the party for whom an appointment is being scheduled (e.g., what does he or she already have scheduled and when), while at the same time viewing more specific information regarding the days on which it is suggested that an appointment be scheduled, such that the scheduler may suggest an optimal date and/or time for the appointment in light of what else is going on in association with the party for whom the appointment is being scheduled.

Prior to scheduling (or in order to schedule) the procedure on the 15^{th}, according to embodiments of the present invention, the scheduler may shift the hybrid timeline, such that the contiguous, and more detailed, portion includes an entry for May 15^{th} of this year (as well as one for each of one or more preceding and/or following days), while the non-contiguous portion continues to include only entries associated with the remaining previously-scheduled semiannual appointments. As noted above, the information included in the more-detailed contiguous entries may include the hours and minutes at which certain equipment and/or personnel are available to schedule the desired appointment. Using this information, the scheduler may select the specific time at which the teeth-whitening procedure should be scheduled on the 15^{th}.

According to one embodiment, the system may further comprise a database 35 associated with or accessible by the central server 30 over the same or different wired or wireless network 20 and storing information that may be used by the central server 30 in providing the appointment scheduling system described above. For example, the database 35 may store, among other things, information regarding the dates and times at which various relevant personnel, facilities, equipment, and/or the like, are available. As well as information regarding what personnel, facilities, equipment and/or the like are capable of being used or assigned to various different types of appointments.

Referring to FIG. 2, a schematic diagram of central server 30 according to one embodiment of the invention is shown. While the foregoing refers to a central “server,” as one of ordinary skill in the art will recognize in light of this disclosure, any central or distributed computing device or network system operating in computer architectures in a client-server architecture or in some other computer architecture may likewise be configured to perform the functionality described herein. Embodiments of the present invention should, therefore not be limited to a single server or to a client-server architecture. Moreover, the designation “central” merely serves to describe the common functionality the server provides for multiple clients or other computing devices and does not require or infer any centralized positioning of the server relative to the other computing devices.

As may be understood from FIG. 2, in this embodiment, the central server 30 may include a processor 205 that communicates with other elements within the central server 30 via a system interface or bus 240. Also included in the central server 30 may be a display device/input device 215 for receiving and displaying data. This display device/input device 215 may be, for example, a keyboard or pointing device that is used in combination with a monitor. A network interface 220, for interfacing and communicating with other elements of a computer network (e.g., electronic device 10) may also be located within the central server 30.

The central server 30 may further include memory 200, which may include both read only memory (ROM) 230 and random access memory (RAM) 225. The server's ROM 230 may be used to store a basic input/output system (BIOS) 235, containing the basic routines that help to transfer information between elements within the central server 30. In addition, the central server 30 may include at least one storage device 210, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 210 may be connected to the system bus 215 by an appropriate interface. The storage devices 210 and their associated computer-readable media may provide nonvolatile storage for a personal computer. It is important to note that the computer-readable media described above could be replaced by any other type of computer-readable media known in the art. Such media may include, for example, magnetic cassettes, flash memory cards, digital video disks, and Bernoulli cartridges.

A number of program modules including, for example, an operating system 250, may be stored by the various storage devices and within RAM 225. According to one embodiment, the central server 30 may store an appointment scheduler module 260, wherein the appointment scheduler module 260 may control certain aspects of the operation of the central server 30, with the assistance of the processor 205 and the operating system 250. While the foregoing describes the software of embodiments of the invention in terms of modules by way of example, as one of ordinary skill in the art will recognize in light of this disclosure, the software associated with embodiments of the invention need not be modularized and, instead, may be intermingled or written in other non-modular formats.

For example, as discussed in more detail below with regard to FIG. 3, according to one embodiment of the present invention, the appointment scheduler module 260 may, among other things, be configured to cause the display of a hybrid timeline that is capable of being used to schedule appointment(s) and includes a contiguous and a non-contiguous portion. As discussed above, according to one embodiment, the contiguous portion may include entries corresponding to consecutive time frames (e.g., days), wherein the first entry may correspond to a suggested time frame (e.g., day) for scheduling the first of several appointments. The non-contiguous portion, which may be used to provide a context for the party for whom an appointment is being scheduled (i.e., to illustrate what else is going on in association with the party), may, in turn, include an entry corresponding to a suggested time frame (e.g., day) for scheduling each of any remaining appointments to be scheduled, as well as an entry corresponding to each previously-scheduled appointment associated with the party. Each portion may display information with some level of detail, wherein the level of detail provided by the contiguous portion may be greater than that provided by the non-contiguous portion.

### Method of Scheduling Appointments

Referring now to FIG. 3, the operations are illustrated that may be taken in order to schedule a set of recurring appointments, such as a set of recurring physical therapy sessions, in accordance with embodiments of the present invention. While the foregoing description relates to scheduling recurring appointments, as one of ordinary skill in the art will recognize, embodiments of the present invention may likewise be used to schedule a single, isolated appointment and/or multiple un-related (i.e., not recurring) appointments. Accordingly, the following description should not in any way be taken as limiting the scope of embodiments of the present invention to scheduling multiple appointments or multiple recurring appointments. In addition, as noted above, while reference is made throughout to scheduling a “new” appointment, as used herein, this may refer to the scheduling of an appointment for the first time or the rescheduling of a previously-scheduled appointment.

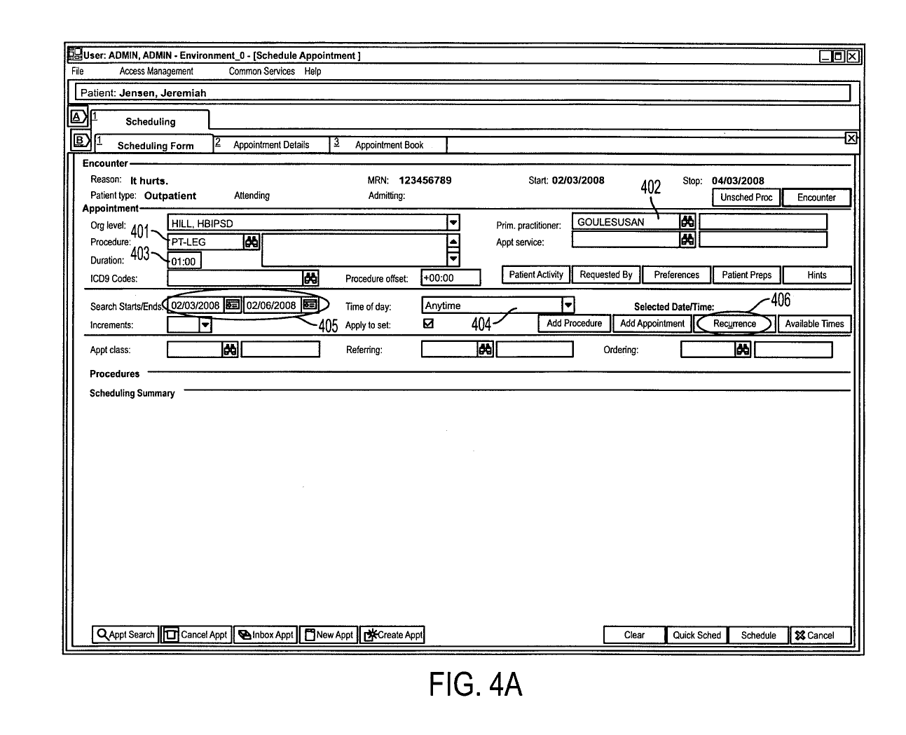

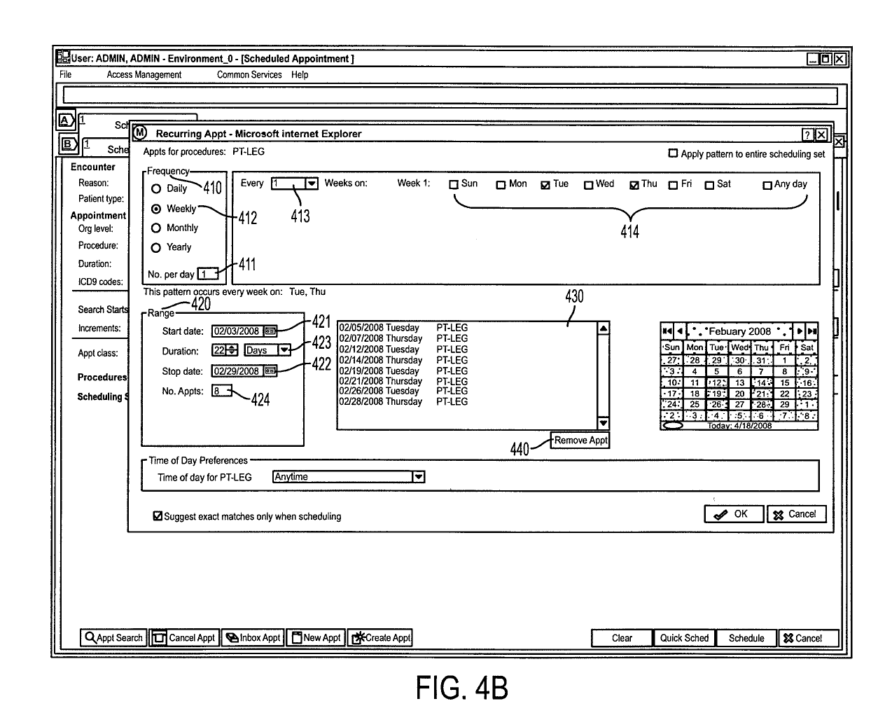

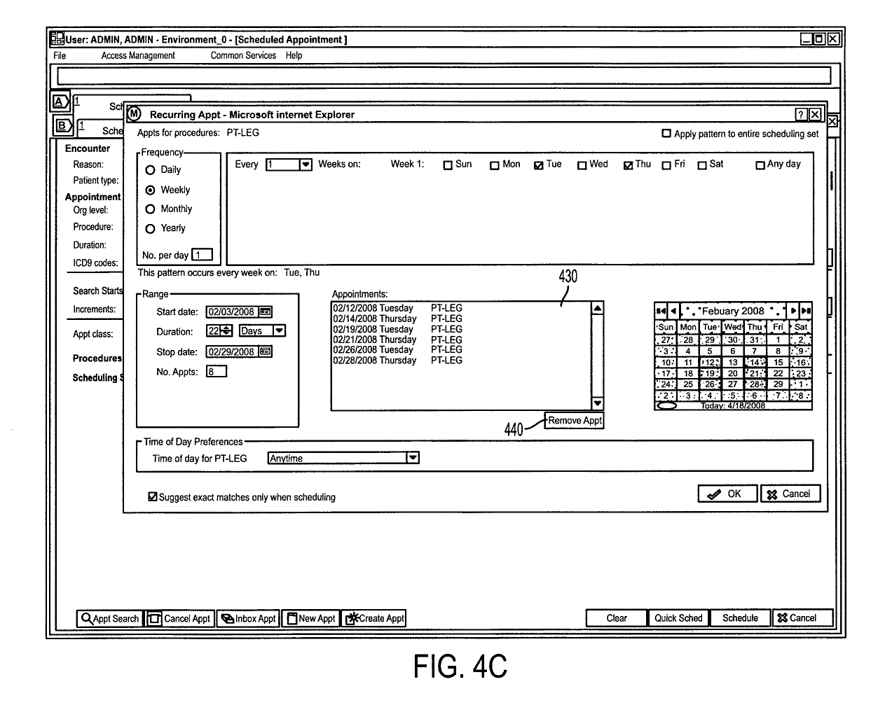

According to one embodiment, the process may begin at Block 301 when a user (e.g., a scheduler) may create a recurring set of appointments to be scheduled by identifying the number of new appointments to be scheduled, as well as the ideal pattern for those new appointments. In order to enable the scheduler to do so, the central server 30 and, according to one embodiment, the processor 205 executing the appointment scheduler module 260 stored on the central server 30, may generate and display a graphical user interface such as the one shown in FIG. 4A.

Using the interface of FIG. 4A, the scheduler may generate a recurring appointment set for providing physical therapy to the patient Jeremiah Jensen. In particular, the scheduler may first identify the type of procedure or appointment desired, which, in this example is physical therapy for Jensen's leg (“PT-Leg”) 401; the primary practitioner for performing the procedure (e.g., Susan Goule—“GOULESUSAN”) 402; the length of each appointment or session (e.g., one hour—“01:00”) 403; the desired time of day for the appointment (e.g., “Anytime”) 404; the date range in which the first appointment should ideally occur (e.g., Feb. 3, 2008 to Feb. 6, 2008) 405; and/or the like. The scheduler may then indicate his or her desire to make the described appointment recurring by, for example, selecting the “Recurrence” button or tab 406.

Upon selecting the Recurrence tab, according to one embodiment of the present invention, the central server 30/appointment scheduler module 260 may generate and cause to be displayed a graphical user interface like that shown in FIG. 4B, from which the scheduler may define a pattern for the recurring appointment set. In particular, using a graphical user interface like that of FIG. 4B, the scheduler may define a frequency 410 associated with the appointment set, as well as a range of dates 420 during which the appointments should ideally occur. For example, with regard to the frequency 410, the scheduler may indicate whether the appointments should occur daily, weekly, monthly or yearly, as well as the number of appointments that should be scheduled per day 411. If, as in the example shown in FIG. 4B, the scheduler selects “Weekly” 412, he or she may further then identify within how many weeks from one another each appointment should occur (e.g., every week) 413; and, if desired, on which day(s) of the week the appointment should ideally occur (e.g., every Tuesday and Thursday) 414. With regard to the range of dates 420 during which the appointments should ideally occur, the scheduler may identify or select the start date 421, the stop date 422, the duration (e.g., the number of days, weeks, etc.) 423, the number of appointments 424, and/or the like.

Using the information provided by the scheduler, the central server 30/appointment scheduler module 260 may, according to one embodiment, generate the set of recurring appointments to be scheduled, wherein the set includes a suggested date for each appointment that coincides with the pattern defined by the scheduler. For example, based on the information provided by the scheduler in the example shown in FIG. 4B, the central server 40/appointment scheduler module 260 may generate a recurring appointment set 430 including eight appointments occurring every Tuesday and Thursday between Feb. 3, 2008 and Feb. 29, 2008.

According to one embodiment, once generated, the scheduler may modify the generated recurring appointment set, for example, by removing one or more appointments from the set. For example, according to one embodiment, in order to remove an appointment from the generated recurring appointment set, the scheduler may highlight, or otherwise select, the appointment(s) to be removed from the list of appointments included in the set 430, and then select the “Remove Appt” button or tab 440. Assuming, for example, that the scheduler selected the appointments scheduled for Feb. 5, 2008 and Feb. 7, 2008 prior to selecting the Remove Appt button 440, the recurring appointment set may be modified, as shown in FIG. 4C, to remove these two appointments from the list of appointments to be included in the set 430.

Returning to FIG. 3, according to embodiments of the present invention, once the recurring appointment set has been generated (i.e., the new appointments to be scheduled have been defined), and the suggested dates have been identified on which each of the new appointments within the set should ideally occur, the central server 30/appointment scheduler module 260 may, at Block 302, identify one or more available dates and times for each of the new appointments. In particular, according to one embodiment, the central server 30/appointment scheduler module 260 may access the database 35 in order to retrieve, for each new appointment, information regarding the availability of the selected physician, necessary equipment, facilities, and/or the like, during the suggested day, as well as during one or more prior and/or subsequent days. Based on the information retrieved, the central server 30/appointment scheduler module 260 may determine at what times on those days all of the necessary personnel and/or equipment are available to schedule the appointment.

In addition to identifying available dates and times for the new appointments to be scheduled, in order to assist the scheduler in scheduling these new appointments, the central server 30/appointment scheduler module 260 of one embodiment may, at Block 303, identify one or more previously-scheduled appointments associated with the party for whom the new appointments are being scheduled (e.g., Jeremiah Jensen), as well as the dates and times associated with those previously-scheduled appointments. For example, the central server 30/appointment scheduler module 260 may identify any appointments Jensen previously scheduled to have performed a physical examination and/or any other procedure that may necessitate Jensen coming to the same, or a nearby, healthcare facility as he may visit for his physical therapy sessions.

Using the information regarding the suggested and available dates and times associated with the new appointments, as well as the dates and times associated with the previously-scheduled appointments, the central server 30/appointment scheduler module 260 of embodiments of the present invention may, at Block 304, generate and cause to be displayed (e.g., on the display screen of the scheduler's electronic device 10) a hybrid timeline that may be used by the scheduler, at Block 305, to schedule each of the new appointments.

In particular, according to one embodiment, the central server 30/appointment scheduler module 260 may generate and cause to be displayed a hybrid timeline including both a contiguous, or sequential, portion and a non-contiguous, or in-sequential, portion. The contiguous portion may include two or more consecutive time entries beginning with a time entry that corresponds to the suggested day associated with the first appointment of the set of appointments to be scheduled. Each time entry of the contiguous portion may include information regarding the available time slots within the corresponding day during which the appointment may be scheduled (e.g., information at a first level of detail).

In contrast, the non-contiguous portion may include only time entries that correspond to the suggested day associated with each of the remaining appointments of the set of appointments, as well as each of the previously-scheduled appointments. Days that are neither a suggested day for scheduling an appointment nor a day on which a previously-scheduled appointment has been scheduled may not be included in the non-contiguous portion of the hybrid timeline, resulting in this portion of the timeline, in many instances, including time entries that are in-sequential. According to embodiments, the non-contiguous portion may include information at a second level of detail that is less than the first level of detail associated with the information included in the contiguous portion. For example, the time entries in the non-contiguous portion may include only a designation of a single start time at which an appointment may be scheduled during the corresponding day not, like the contiguous portion, an indication of all of the available time slots within the day during which the appointment may be scheduled.

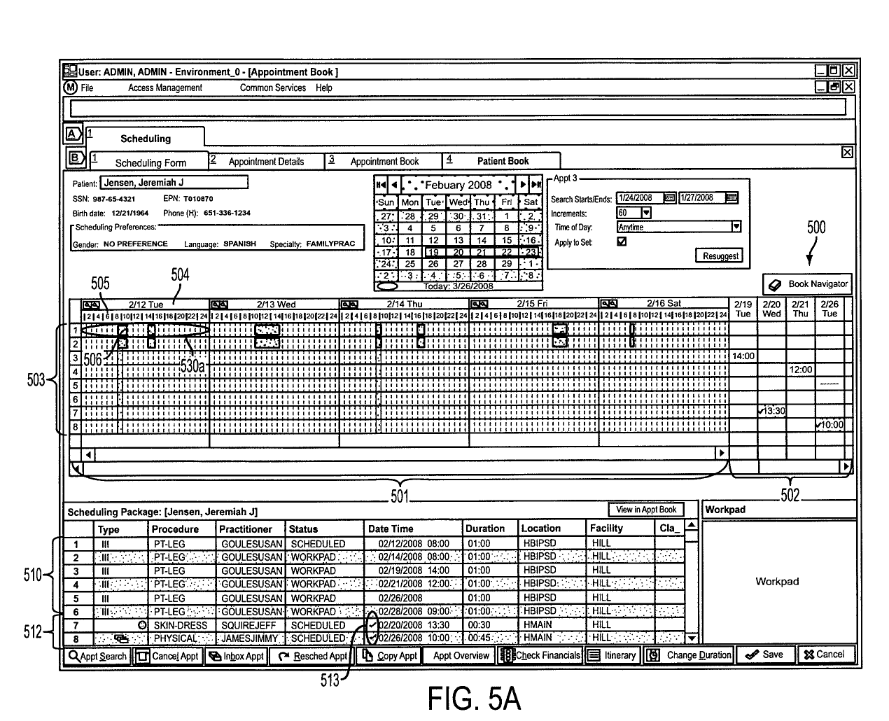

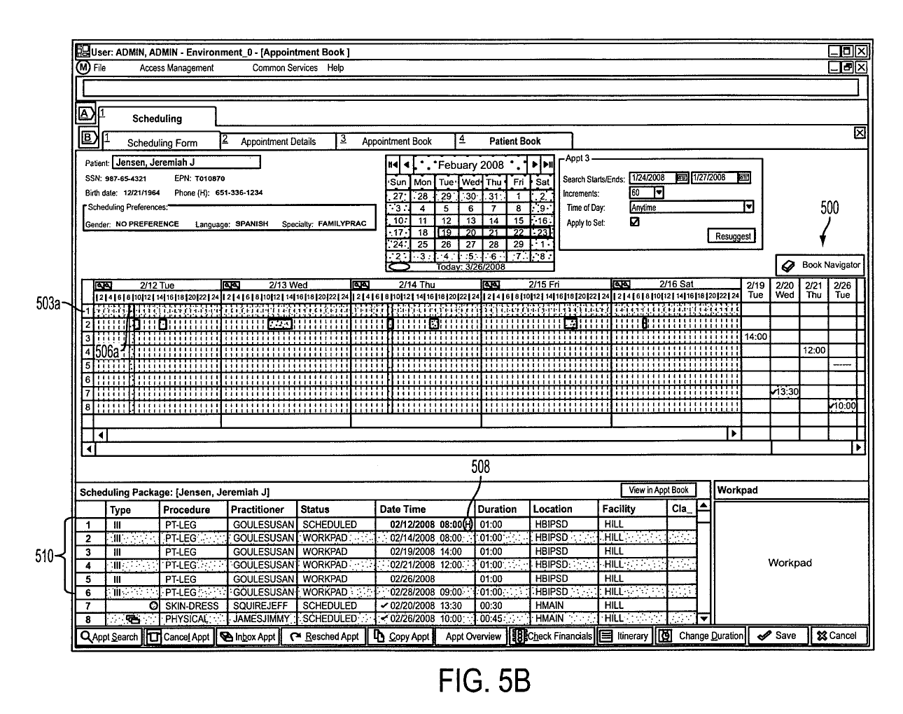

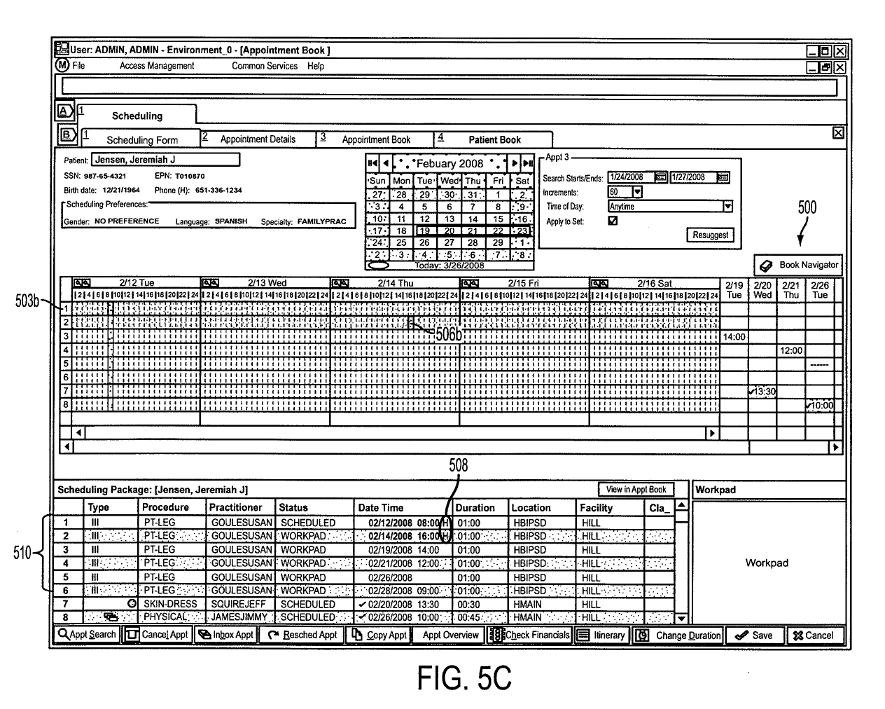

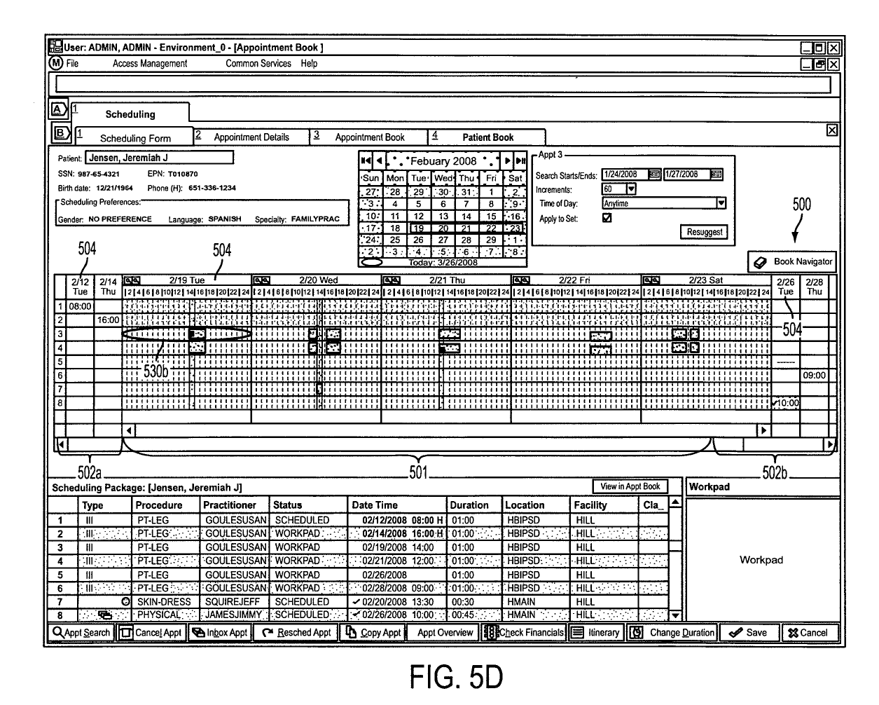

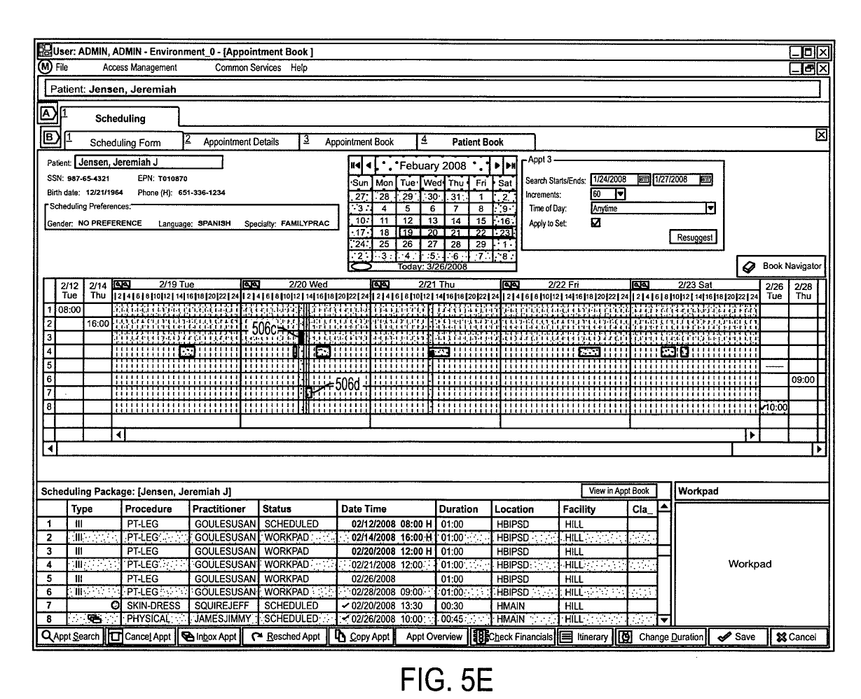

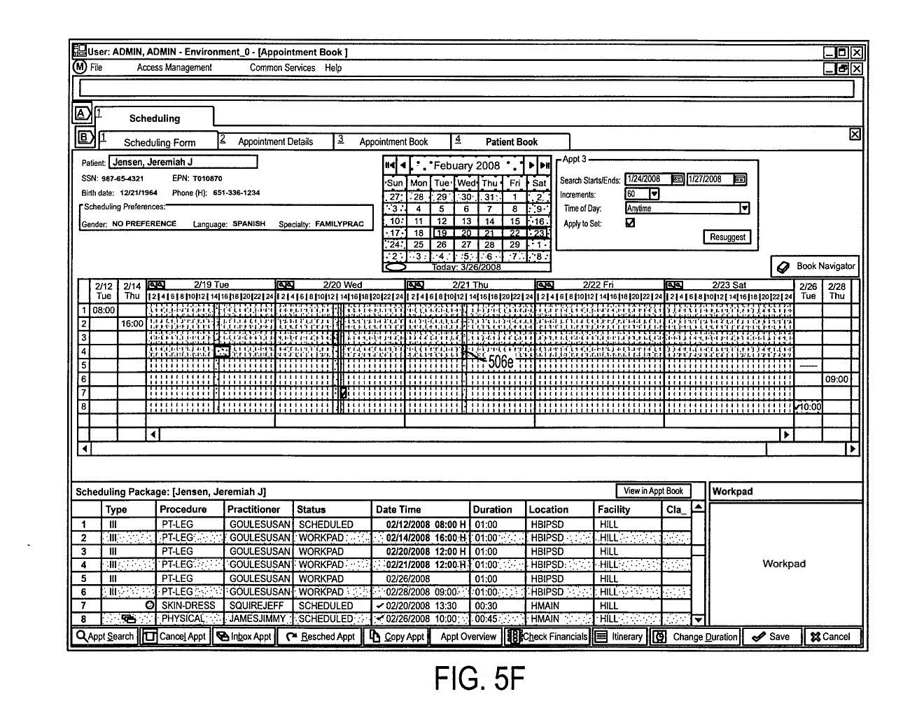

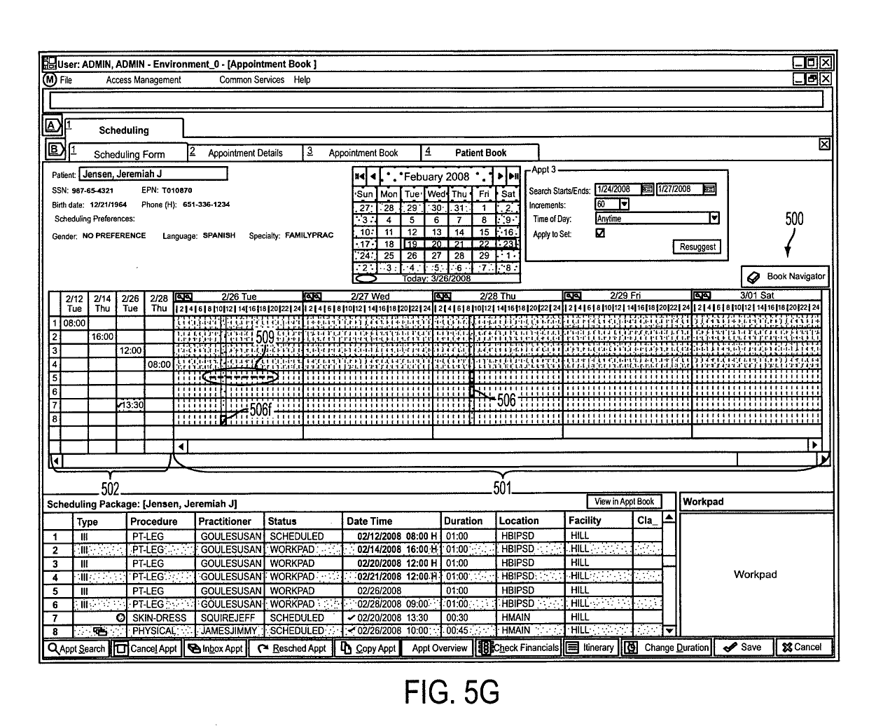

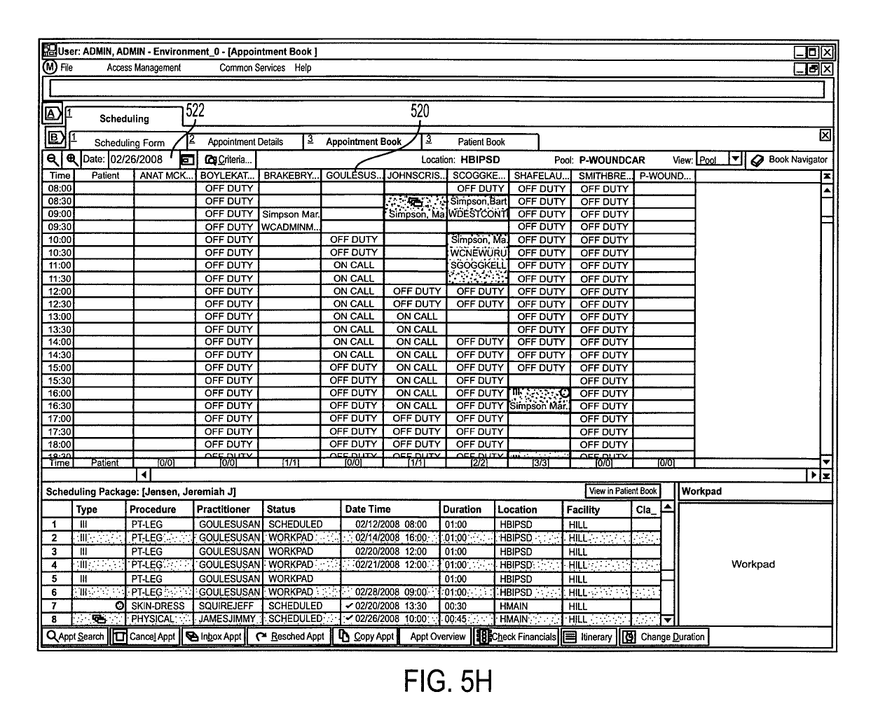

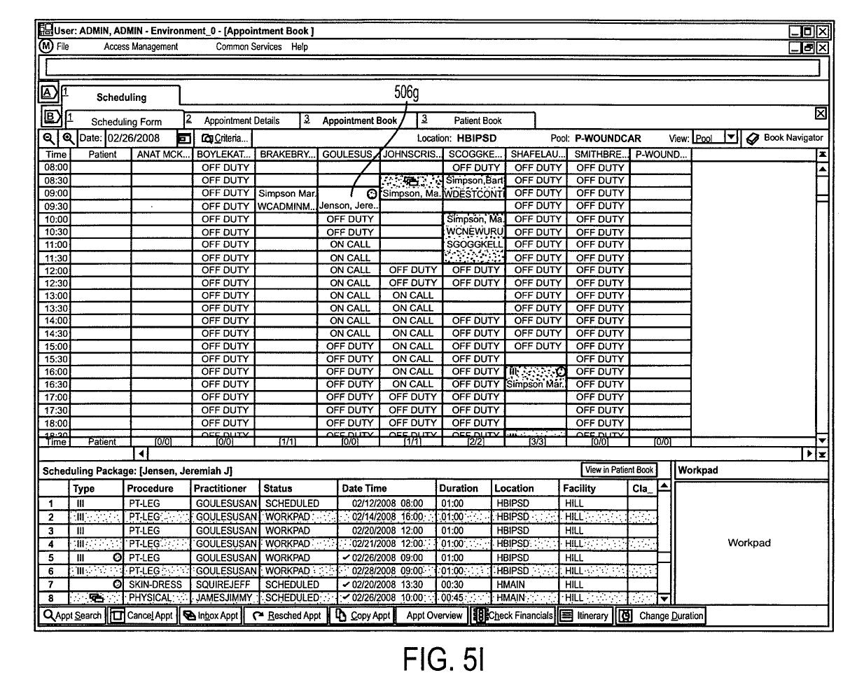

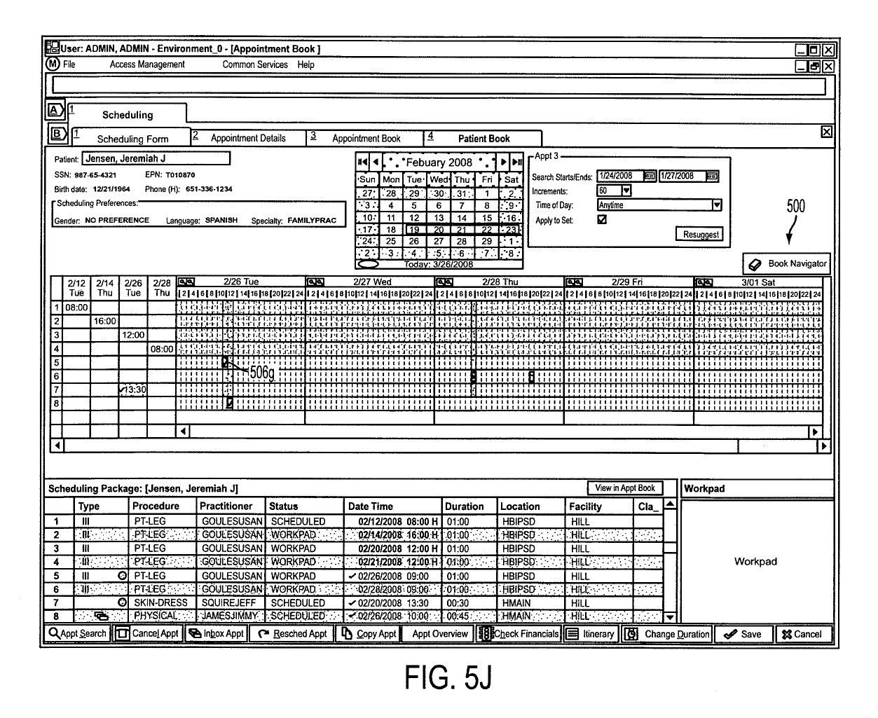

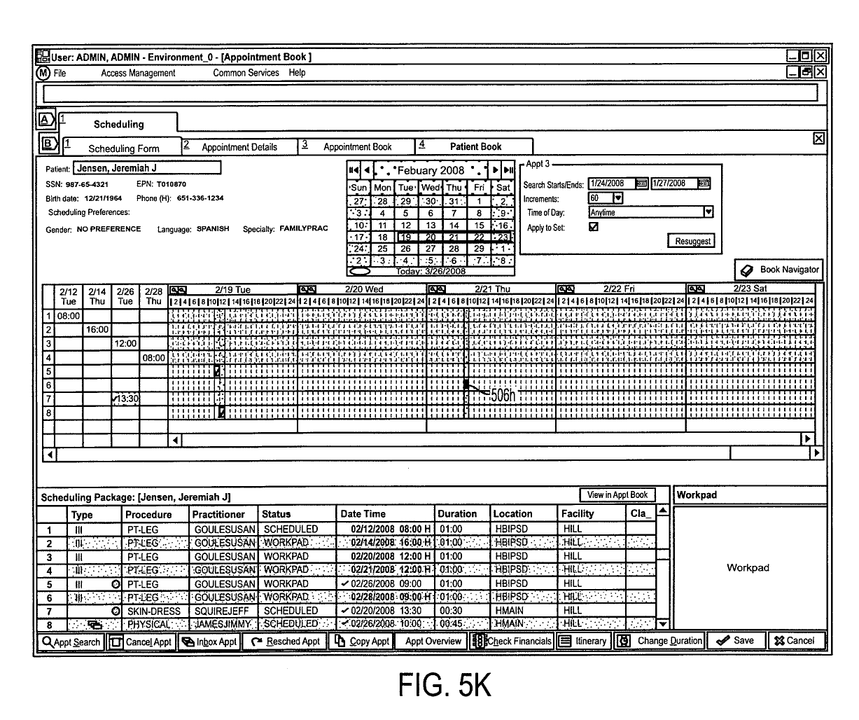

To illustrate the foregoing, reference is made to FIGS. 5A through 5K, which provide an example of a graphical user interface that may be generated by the central server 50/appointment scheduler module 260 for use in by the scheduler (e.g., via the scheduler's electronic device 10) to schedule appointments of a recurring appointment set in accordance with an embodiment of the present invention. In particular FIGS. 5A through 5K illustrate the graphical user interface that may be used to schedule the recurring physical therapy sessions for Jeremiah Jensen described above.

Referring to FIG. 5A, according to one embodiment, the graphical user interface may include a list of both the new appointments to be scheduled 510 and the previously-scheduled appointments 512 associated with Jeremiah Jensen. As shown, in addition to the six new physical therapy sessions 510 to be scheduled for Jensen (e.g., created as described above using the interface of FIGS. 4A-4C), there are two appointments 512 that were previously scheduled for Jensen including an appointment to have a physical examination, and an appointment to have a dressing (e.g., clean gauze) applied to Jensen's skin. According to one embodiment, the entry in the list associated with each appointment (scheduled and to be scheduled) may include an indication of, among other things, the type of procedure or appointment (e.g., PT-Leg, Physical, etc.), the practitioner responsible for seeing the patient, the status of the appointment (e.g., whether it has been scheduled or is still part of the “WORKPAD” to be scheduled), the duration (e.g., an hour, 30 minutes, 45 minutes, etc.), the suggested or scheduled date and time, and/or the like. In addition, once an appointment has been scheduled and confirmed, a check mark, or similar designator, 413 may be included next to the date and time associated with the confirmed appointment. According to the embodiment shown, the list of appointments to be scheduled (e.g., Jensen's physical therapy sessions) may be chronological and may precede a chronological list of the previously-scheduled appointments. Alternatively, while not shown, an overall chronological list may be provided wherein the scheduled and to-be scheduled appointments are intermingled with one another.

As further shown in FIG. 5A, the graphical user interface may also include the hybrid timeline 500 described above including both a contiguous 501 and a non-contiguous 502 portion. In particular, according to the embodiment shown, the hybrid timeline 500 may comprise a grid or table including a number of rows 503 and columns 504, wherein each row 503 may correspond to a different appointment scheduled or to be scheduled. Each column 504 may further correspond to a different period of time, such as a day, wherein the columns associated with the contiguous portion 501, while corresponding to the same period of time (e.g., day) as the columns associated with the non-contiguous portion 502, may be wider than those of the non-contiguous portion 502, and may further be broken down into sub-columns 505 corresponding to smaller periods of time, such as hours.

As discussed above and as shown, the contiguous portion 501 may include a column 504 corresponding to the suggested date for scheduling the first appointment of the set of recurring appointments (e.g., Feb. 12, 2008) followed by a column 504 corresponding to the next four consecutive dates (e.g., Feb. 13-16, 2008). Within each of these columns 504 may be a sub-column 505 for each hour of the day. In contrast, the non-contiguous portion 502 may include only a column 504 corresponding to either the dates on which a previously-scheduled appointment has been scheduled (e.g., Feb. 20, 2006 and Feb. 26, 2006) or a suggested date for scheduling a new appointment (e.g., Feb. 19, 2008 and Feb. 21, 2008). In this manner, the non-contiguous portion 502 may eliminate any columns, and, therefore, time entries, associated with dates on which nothing is occurring, or suggested to occur, in relation to the patient, wherein a time entry may correspond to a segment of a single row that lies within a single column. For example, a time entry 530a associated with scheduling the first appointment on the suggested day for the first appointment (e.g., Feb. 12, 2008) may correspond to a segment of the first row that lies in the first column, or the column corresponding to Feb. 12, 2008.

In addition, the columns 504 of the non-contiguous portion 502 may be narrower and may not include any sub-columns 505 corresponding to a smaller period of time. In other words, according to one embodiment of the present invention, the level of detail of information included in the columns of the contiguous portion 501 (e.g., days and hours) may be greater than the level of information included in the columns of the non-contiguous portion 502 (e.g., days alone). In this manner, a scheduler may be able to simultaneously view more detail in relation to certain dates, while still being able to view information regarding the patient (e.g., the context of the patient) that is spread out over a vast amount of time.

As further shown in FIG. 5A, in order to assist the scheduler in scheduling one of the appointments of the recurring appointment set, the graphical user interface may further designate, within the contiguous portion 501, the available time slots 506 for scheduling the appointment on the suggested day, as well as the four subsequent consecutive days. The graphical user interface may do so, for example, by coloring, highlighting, or otherwise differentiating, the available slots 506 from those that are not available. For example, as shown, the available time slots 506 for scheduling the first appointment on its suggested day of Feb. 12, 2008 are between 8:00 AM and 10:00 AM and between 14:00 PM and 15:30 PM, while the available time slots 506 for scheduling the second appointment on its suggested day of Feb. 14, 2008 (which is within four consecutive days of the suggested date of the first appointment and may, therefore, be included within the contiguous portion 501 of the timeline when the scheduler is scheduling the first appointment of the set) are between 8:00 AM and 9:00 AM and between 16:00 PM and 18:00 PM.

In order to schedule an appointment on one of the available dates and times, according to one embodiment, the scheduler may simply select the time slot 506 associated with the desired date and time. As shown in FIG. 5B, upon selecting the desired time slot associated with the first appointment to be scheduled (e.g., between 8:00 AM and 9:00 AM on Feb. 12, 2008) 506a, the remaining available time slots may be removed, and the row corresponding to the first appointment 503a may be highlighted, or otherwise differentiated from the remaining rows of the timeline 500, in order to indicate that this appointment has, at least tentatively, been scheduled. In addition, the entry associated with the tentatively scheduled appointment in the list of appointments to be scheduled 510 may be updated to reflect the date and time associated with the selected time slot, and to add an “H” 508, or similar designator, to indicate that the selected time slot is on hold, until later confirmed. FIG. 5C illustrates a similar modification to the graphical user interface when the scheduler tentatively schedules the second appointment (corresponding to row 503b) of the set of appointments for the time slot 506b between 16:00 PM and 17:00 PM on Feb. 14, 2008.

When proceeding to schedule the third appointment in the recurring appointment set, in order to view more detailed information regarding the likely days on which this appointment will be scheduled, the scheduler may need (or desire) to shift the hybrid timeline 500, so that the contiguous (and more detailed) portion 501 corresponds to those days. For example, as shown in FIG. 5D, the hybrid timeline 500 may be shifted so that the contiguous portion 501 includes a column 504 (and, therefore a time entry 530b) corresponding to the suggested day for scheduling the third appointment (e.g., Feb. 19, 2008), and one for each of the immediately subsequent four days (e.g., Feb. 20-23, 2008). Because the patient now has appointments scheduled or to be scheduled both prior to and following the dates associated with the shifted contiguous portion 501 of the hybrid timeline 500, the non-contiguous portion 502 may be split to include one section 502a displayed to the left of the contiguous portion 501 and including the relevant days occurring before the suggested date of the third appointment (e.g., Feb. 12, 2008 and Feb. 14, 2008, or the tentatively scheduled dates for the first two appointments), and another section 502b displayed to the right of the contiguous portion 501 and including the relevant days occurring after the last date of the contiguous portion 501 (e.g., Feb. 26, 2008 and Feb. 28, 2008, or the suggested dates for scheduling the fifth and sixth appointments of the recurring appointment set). The scheduler may then use this updated, or shifted, hybrid timeline 500 to hold available time slots 506 for the third and fourth appointments (since the suggested day for the fourth appointment falls within the days included in the contiguous portion 501), for example, in the manner described above.

In this instance, however, the patient already has an appointment scheduled for a day that falls within the dates displayed within the contiguous portion 501 of the hybrid timeline 500. In particular, the patient has an appointment scheduled for Feb. 20, 2008 to have a dressing (e.g., clean gauze) applied to his skin, while the suggested days for scheduling two of the patient's recurring physical therapy sessions are on Feb. 19, 2008 and Feb. 21, 2008. As a result, if the scheduler were to schedule the third and fourth appointments on the suggested dates, the patient would be required to visit the healthcare facility on three consecutive days. In order to avoid this, the scheduler may, for example, schedule the third appointment for the same day as the previously-scheduled appointment, rather than the day before. For example, as shown in FIG. 5E, the scheduler may select the available time slot 506c between 12:00 PM and 13:00 PM on Feb. 20, 2008 for the third appointment, since the previously-scheduled appointment occupies the time slot 506d between 13:30 PM and 14:00 PM on that same day. As shown in FIG. 5F, the scheduler may thereafter select the time slot 506e between 12:00 PM and 13:00 PM on Feb. 21, 2008 for the fourth appointment of the recurring appointment set.

Finally, the scheduler may then proceed in a similar manner to schedule the fifth and final physical therapy sessions for Jeremiah Jensen. As above and as shown in FIG. 5G, the hybrid timeline 500 may again shift so that the contiguous portion 501 displays columns and, therefore, time entries associated with the suggested day for the fifth appointment (e.g., Feb. 26, 2008), as well as the subsequent consecutive days (e.g., Feb. 27-Mar. 1, 2008). As shown, because a previously-scheduled appointment for a physical examination, as well as the sixth and final recurring appointment, fall within the subsequent consecutive days (e.g., on Feb. 26, 2008 and Feb. 28, 2008, respectively), the contiguous portion 501 of the timeline may also include reference to these appointments (e.g., the time slot associated with the previously-scheduled appointment 506f and the available time slots 506 for the final appointment). In addition, because all of the remaining tentatively and previously scheduled appointments now occur on days preceding the days associated with the contiguous portion 501, the entire non-contiguous portion 502 may be displayed to the left of the contiguous portion 501.

However, as indicated by the dashed lines 509 shown in FIG. 5G, in this example there may be no available time slots for scheduling the fifth appointment on the suggested day associated with that appointment (e.g., Feb. 26, 2008). In other words, according to one embodiment, the central server 30/appointment scheduler module 260 may have determined (e.g., by accessing the database 35) that the personnel and/or equipment necessary to offer or provide a physical therapy session at any time on the suggested day are unavailable.

According to one embodiment, the scheduler may still be permitted to schedule an appointment on the suggested day by, for example, accessing a graphical user interface like the one shown in FIG. 5H. As shown, this interface may include, for example, more detailed information regarding the schedules associated with one or more caregivers, including Susan Goule 520 (i.e., the physician selected for Jensen's physical therapy sessions), for the day on which the scheduler desires to schedule the appointment (e.g., Feb. 26, 2008) 522. From this interface, the scheduler may, for example, note that Goule does not have anything scheduled for the time periods between 8:00 AM and 10:00 AM, nor is she off duty during those time periods. As a result, the scheduler may, as shown in FIG. 51, schedule Jeremiah Jensen's appointment for the time period between 9:00 AM and 10:00 AM 506g. As shown in FIG. 5J, the hybrid timeline 500 may be updated to reflect that Jensen's fifth appointment has been scheduled (and, in this embodiment, confirmed) for the selected time period 506g, despite the fact that it was not previously designated as available. Finally, as shown in FIG. 5K, the scheduler may select an available time slot 506h for the sixth and final appointment of the recurring appointment set for Jeremiah Jensen.

While the foregoing provides an example of the process that may be performed in order to schedule appointment(s), the order described above of the steps performed in relation to that process is provided for exemplary purposes only and should not be taken in any way as limiting the scope of embodiments of the present invention to the particular order provided. Alternatively, as one of ordinary skill in the art will recognize in light of this disclosure, the foregoing steps may be preformed in multiple different orders and combinations without departing from the spirit and scope of embodiments of the present invention. In addition, while the foregoing illustrates the scheduling of a set of recurring physical therapy sessions, as one of ordinary skill in the art will recognize in light of this disclosure, embodiments of the present invention may similarly be used to schedule single or multiple non-recurring appointments of any type or kind including, for example, appointments to have yard work done, your house cleaned, your pet groomed, your car washed and/or serviced, and/or the like. Accordingly, embodiments of the present invention are not limited to use in scheduling the type or number of appointments described above.

### Conclusion

As described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 205 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 205 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1 An apparatus comprising:
a processor configured to:
cause a display of a timeline capable of being used to schedule an appointment, said timeline comprising a contiguous portion and a non-contiguous portion,
wherein the contiguous portion comprises two or more entries corresponding to two or more consecutive time frames, a first of said entries corresponding to a suggested time frame for scheduling a first of a plurality of new appointments,
and wherein the non-contiguous portion only comprises an entry corresponding to a suggested time frame for scheduling respective remaining new appointments of the plurality of new appointments, and an entry corresponding to a time frame within which respective appointments of one or more previously-scheduled appointments has been scheduled, without comprising an entry that fails to correspond to either a suggested time frame for scheduling one of the plurality of new appointments or a time frame within which one of the one or more previously-scheduled appointments has been scheduled.

2. The apparatus of claim 1, wherein respective entries of the contiguous portion display information comprising a first level of detail, respective entries of the non-contiguous portion display information comprising a second level of detail, and wherein the second level of detail is less than the first level of detail.

3. The apparatus of claim 2, wherein the processor is further configured to:
receive an indication of a plurality of new appointments to be scheduled; and
receive an indication of a particular day on which respective new appointments of the plurality of new appointments should be scheduled,
wherein the suggested time frame corresponding to respective entries of the contiguous and non-contiguous portions correspond to the particular day associated with the corresponding new appointment.

4. The apparatus of claim 1, wherein the processor is further configured to:
receive an indication of a day on which respective one or more previously-scheduled appointments has been scheduled, wherein the entry corresponding to the time frame within which respective appointments of one or more previously-scheduled appointments has been scheduled corresponds to the day on which the corresponding previously-scheduled appointment has been scheduled.

5. The apparatus of claim 3, wherein the processor is further configured to:
identify one or more time periods within respective particular days during which scheduling the corresponding new appointment will not result in a conflict.

6. The apparatus of claim 5, wherein the processor is further configured to:
identify one or more time periods within respective one or more consecutive days following the particular day associated with the first new appointment during which scheduling the corresponding new appointment will not result in a conflict,
wherein the information displayed by respective entries of the contiguous portion comprises the identified time periods.

7. The apparatus of claim 5, wherein the processor is further configured to:
select one of the one or more identified time periods within respective particular days,
wherein the information displayed by respective entries of the non-contiguous portion corresponding to respective remaining new appointments comprises the selected time period.

8. The apparatus of claim 1, wherein the timeline further comprises a row corresponding to respective new appointments of the plurality of new appointments and a row corresponding to respective one or more previously-scheduled appointments.

9. A method comprising:
generating a timeline capable of being used to schedule an appointment, said timeline comprising a contiguous portion and a non-contiguous portion,
wherein the contiguous portion comprises two or more entries corresponding to two or more consecutive time frames, a first of said entries corresponding to a suggested time frame for scheduling a first of a plurality of new appointments,
and wherein the non-contiguous portion only comprises an entry corresponding to a suggested time frame for scheduling respective remaining new appointments of the plurality of new appointments, and an entry corresponding to a time frame within which respective appointments of one or more previously-scheduled appointments has been scheduled, without comprising an entry that fails to correspond to either a suggested time frame for scheduling one of the plurality of new appointments or a time frame within which one of the one or more previously-scheduled appointments has been scheduled; and
causing a display of the timeline.

10. The method of claim 9, wherein respective entries of the contiguous portion display information comprising a first level of detail, respective entries of the non-contiguous portion display information comprising a second level of detail, and wherein the second level of detail is less than the first level of detail.

11. The method of claim 10, further comprising:
receiving an indication of a plurality of new appointments to be scheduled; and
receiving an indication of a particular day on which respective new appointments of the plurality of new appointments should be scheduled,
wherein the suggested time frame corresponding to respective entries of the contiguous and non-contiguous portions correspond to the particular day associated with the corresponding new appointment.

12. The method of claim 9 further comprising:
receiving an indication of a day on which respective one or more previously-scheduled appointments has been scheduled, wherein the entry corresponding to the time frame within which respective appointments of one or more previously-scheduled appointments has been scheduled corresponds to the day on which the corresponding previously-scheduled appointment has been scheduled.

13. The method of claim 11 further comprising:
identifying one or more time periods within respective particular days during which scheduling the corresponding new appointment will not result in a conflict.

14. The method of claim 13 further comprising:
identifying one or more time periods within respective one or more consecutive days following the particular day associated with the first new appointment during which scheduling the corresponding new appointment will not result in a conflict,
wherein the information displayed by respective entries of the contiguous portion comprises the identified time periods.

15. The method of claim 13 further comprising:
selecting one of the one or more identified time periods within respective particular days,
wherein the information displayed by respective entries of the non-contiguous portion corresponding to respective remaining new appointments comprises the selected time period.

16. The method of claim 9, wherein the timeline further comprises a row corresponding to respective new appointments of the plurality of new appointments and a row corresponding to respective one or more previously-scheduled appointments.

17. A computer program product comprising at least one computer-readable storage medium having computer-readable program code portions stored therein, the computer-readable program code portions comprising:
a first executable portion for generating a timeline capable of being used to schedule an appointment, said timeline comprising a contiguous portion and a non-contiguous portion,
wherein the contiguous portion comprises two or more entries corresponding to two or more consecutive time frames, a first of said entries corresponding to a suggested time frame for scheduling a first of a plurality of new appointments,
and wherein the non-contiguous portion only comprises an entry corresponding to a suggested time frame for scheduling respective remaining new appointments of the plurality of new appointments, and an entry corresponding to a time frame within which respective appointments of one or more previously-scheduled appointments has been scheduled, without comprising an entry that fails to correspond to either a suggested time frame for scheduling one of the plurality of new appointments or a time frame within which one of the one or more previously-scheduled appointments has been scheduled; and
a second executable portion causing a display of the timeline.

18. The computer program product of claim 17, wherein respective entries of the contiguous portion display information comprising a first level of detail, respective entries of the non-contiguous portion display information comprising a second level of detail, and wherein the second level of detail is less than the first level of detail.

19. The computer program product of claim 18, wherein the computer-readable program code portions further comprise:
a third executable portion for receiving an indication of a plurality of new appointments to be scheduled; and
a fourth executable portion for receiving an indication of a particular day on which respective new appointments of the plurality of new appointments should be scheduled,
wherein the suggested time frame corresponding to respective entries of the contiguous and non-contiguous portions correspond to the particular day associated with the corresponding new appointment.

20. The computer program product of claim 17, wherein the computer-readable program code portions further comprise:
a third executable portion for receiving an indication of a day on which respective one or more previously-scheduled appointments has been scheduled, wherein the entry corresponding to the time frame within which respective appointments of one or more previously-scheduled appointments has been scheduled corresponds to the day on which the corresponding previously-scheduled appointment has been scheduled.

21. The computer program product of claim 19, wherein the computer-readable program code portions further comprise:
a fifth executable portion for identifying one or more time periods within respective particular days during which scheduling the corresponding new appointment will not result in a conflict.

22. The computer program product of claim 21, wherein the computer-readable program code portions further comprise:
a sixth executable portion for identifying one or more time periods within respective one or more consecutive days following the particular day associated with the first new appointment during which scheduling the corresponding new appointment will not result in a conflict,
wherein the information displayed by respective entries of the contiguous portion comprises the identified time periods.

23. The computer program product of claim 21, wherein the computer-readable program code portions further comprise:
a sixth executable portion for selecting one of the one or more identified time periods within respective particular days,
wherein the information displayed by respective entries of the non-contiguous portion corresponding to respective remaining new appointments comprises the selected time period.

24. The computer program product of claim 17, wherein the timeline further comprises a row corresponding to respective new appointments of the plurality of new appointments and a row corresponding to respective one or more previously-scheduled appointments.
